(19) United States
(12) Patent Application Publication
(10) Pub. No.: US 2008/0149260 A1
(43) Pub. Date: Jun. 26, 2008

(54) Method For Making A Running Tread For A Tire

(76) Inventor: Thierry Orsat, Chatel-Guyon (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/793,173

(22) PCT Filed: Dec. 13, 2005
(86) PCT No.: PCT/EP2005/056721

§ 371 Date: Nov. 23, 2007

(30) Foreign Application Priority Data
Dec. 24, 2004 (FR) 0413962
Feb. 1, 2005 (FR) 0501127

(51) Int. Cl. B29D 30/08; B28B 19/00

(52) U.S. Cl. 156/128.6; 264/328.3; 156/394.1

(57) ABSTRACT

A method of manufacturing a tire, said tire including a tread essentially consisting of a base compound, the tread furthermore including at least one insert of an insertion compound, said method comprising steps consisting in: preparing a tread (7) made of an uncured base compound (MB); injecting, into the uncured tread, a defined quantity of the uncured insertion compound (MI) in a position defined in relation to the uncured tread; and molding said tread.

The present invention relates to the manufacture of tires, more precisely, it relates to the manufacture of tires in which the tread comprises one or more inserts of an elastomeric material different from the elastomeric material constituting most of said tread.

It is known to design tires in which the tread comprises various rubber compounds. Application WO 03/089257 discloses examples of such treads.

The industrial manufacture of such treads poses difficulties. In particular, certain desirable effects can be obtained only if the position of the inserts of elastomeric material in the final tread (that is to say after molding) is sufficiently precise and reproducible. Likewise, it may be desirable for the dimensions of these inserts also to be precise and reproducible. Such industrial manufacture must also be economical.

The objective of the invention is to provide a method and a device for manufacturing tires in which the tread includes inserts of different elastomeric material which make it possible to overcome at least some of the aforementioned difficulties.

To do this, the invention provides a method of manufacturing a tire, said tire including a tread essentially consisting of a base compound, the tread furthermore including at least one insert of an insertion compound, said method comprising steps consisting in:

preparing a tread made of an uncured base compound;

injecting, into the uncured tread, a defined quantity of the uncured insertion compound in a position defined in relation to the uncured tread;

molding said tread.

Preferably, the insertion compound is injected into the uncured tread via a nozzle after the end of the nozzle has been sunk into the uncured tread. Preferably, the end of the nozzle is extracted from the uncured tread at the latest during injection of the insertion compound.

Preferably, the insertion compound is conveyed toward the end of the nozzle using an extruder, preferably a volumetric extruder and, more preferably, via a plurality of substantially parallel ducts.

Preferably, the final tread molding step is carried out so as to form cuts in the surface of the tread, at least one wall of said cuts consisting at least partly of insertion compound.

Preferably, a plurality of inserts are injected simultaneously so as to cover a part of the tread corresponding to a base pattern feature of the tire tread pattern.

According to a preferred embodiment of the invention, the tire is assembled and molded on a core, the shape of the core being close to the final shape of the internal cavity of the tire.

Preferably, the molded tread including a tread pattern and the position (P) of said insert is defined relative to the tread pattern, said method comprising the steps consisting in:

injecting said insert into the uncured tread in a position defined relative to the core;

positioning said core carrying said uncured tire and said insert in an external mold along a defined azimuth.

The invention also relates to a device for manufacturing a tire according to the above method, said device comprising a rotary core capable of supporting the uncured tire, feed means for feeding a nozzle with an uncured insertion compound and means for positioning the nozzle relative to the core.

Preferably, the external shape of the end of the nozzle corresponds substantially to the shape of the insert.

Preferably, the means for feeding the uncured insertion compound comprise an extruder, preferably a volumetric extruder.

Preferably, the device furthermore includes means for indexing the position of the insert or inserts relative to the molded tread.

Preferably, the indexing means comprise a first index associated with the core and capable of cooperating with a complementary first index associated with a driving member for driving the core during assembly of the uncured tire and including a second index associated with the core and capable of cooperating, during molding, with a complementary second index associated with the external mold.

Preferably, the first and second indices constitute a single means.

Preferably, the nozzle comprises a plurality of essentially parallel ducts.

Preferably, the device comprises a plurality of integral nozzles arranged in a base tire tread pattern, said plurality of nozzles being fed by common feed means.

Other advantages of the invention will also become apparent from the description of the following figures:

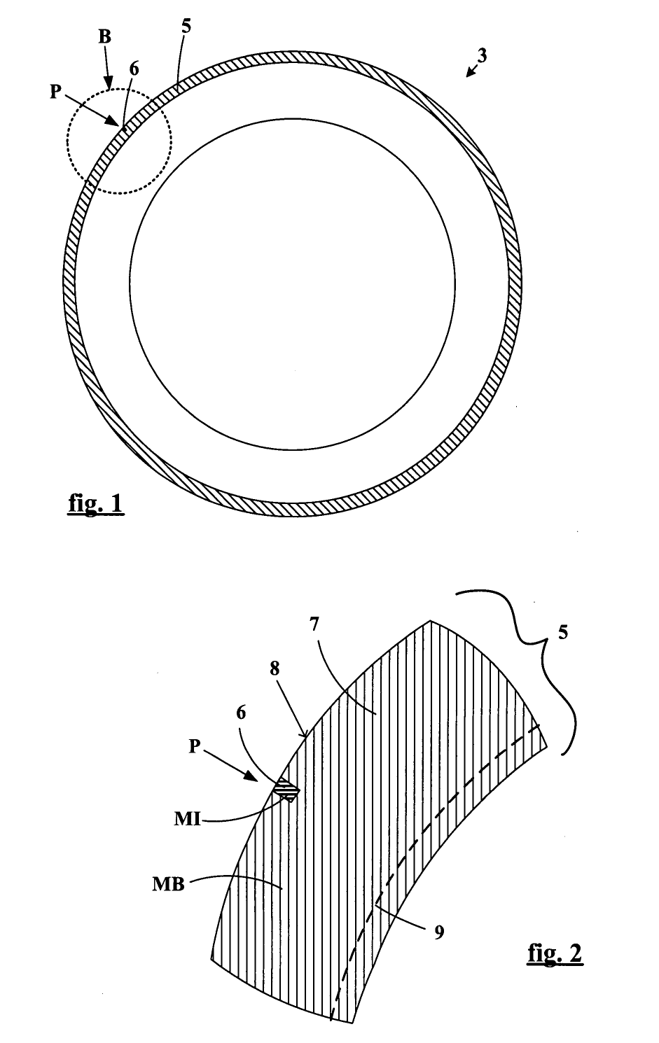

FIG. 1 is a schematic sectional view in a plane perpendicular to the axis of a tire that includes an insert according to the invention;

FIG. 2 is a detailed view of part of the tire contained in the circle B of FIG. 1;

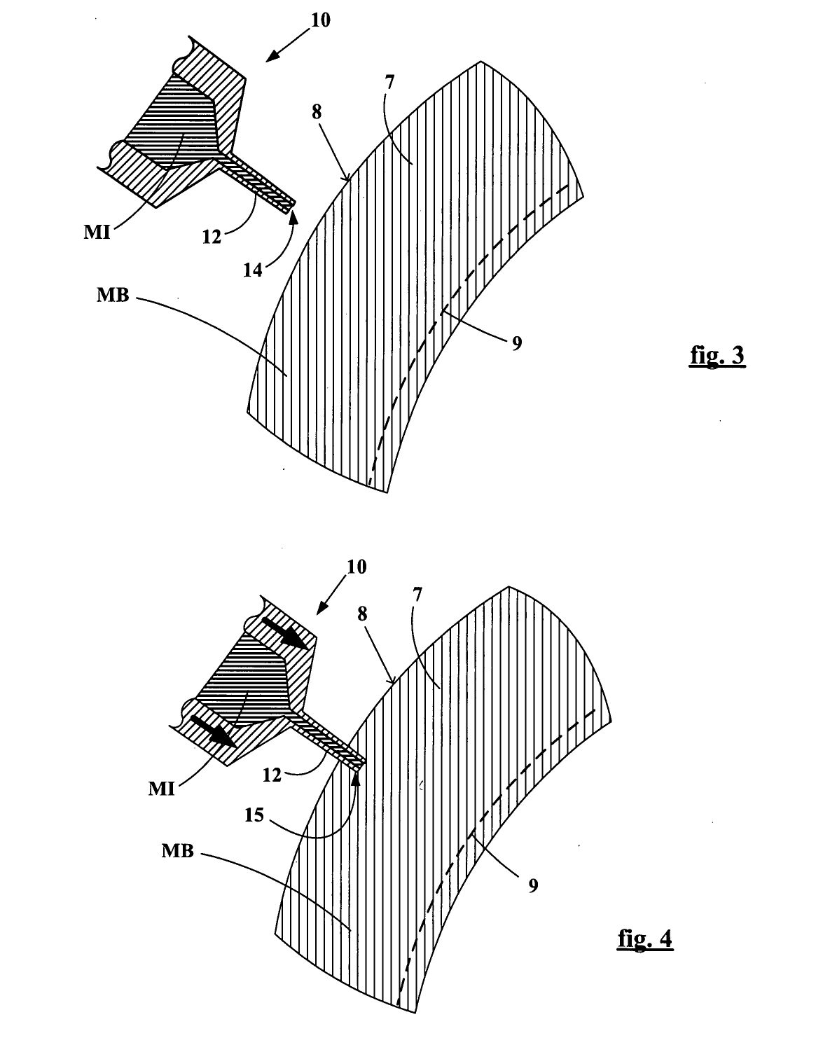

FIGS. 3 to 11 show schematically one way of implementing the method of the invention;

FIG. 12 is a schematic view of the molding of an incision using the method of the invention;

FIG. 13 is a schematic view of the molding of a tread pattern block using the method of the invention;

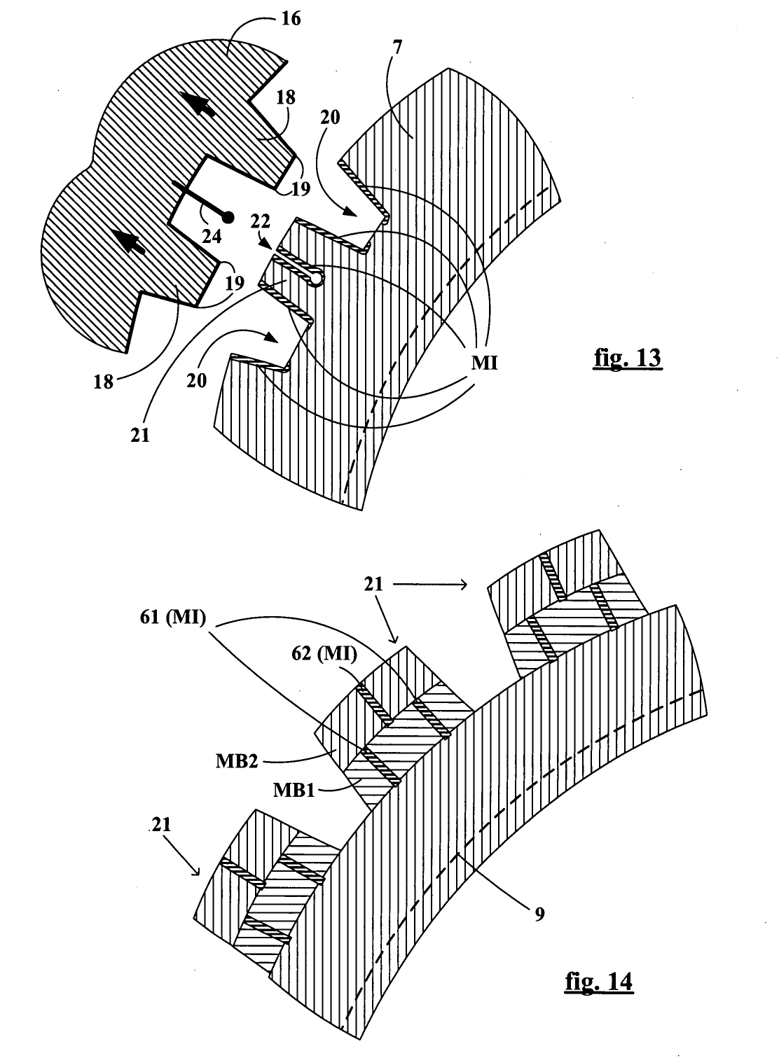

FIG. 14 is a schematic view of another example of a tread produced using the method of the invention;

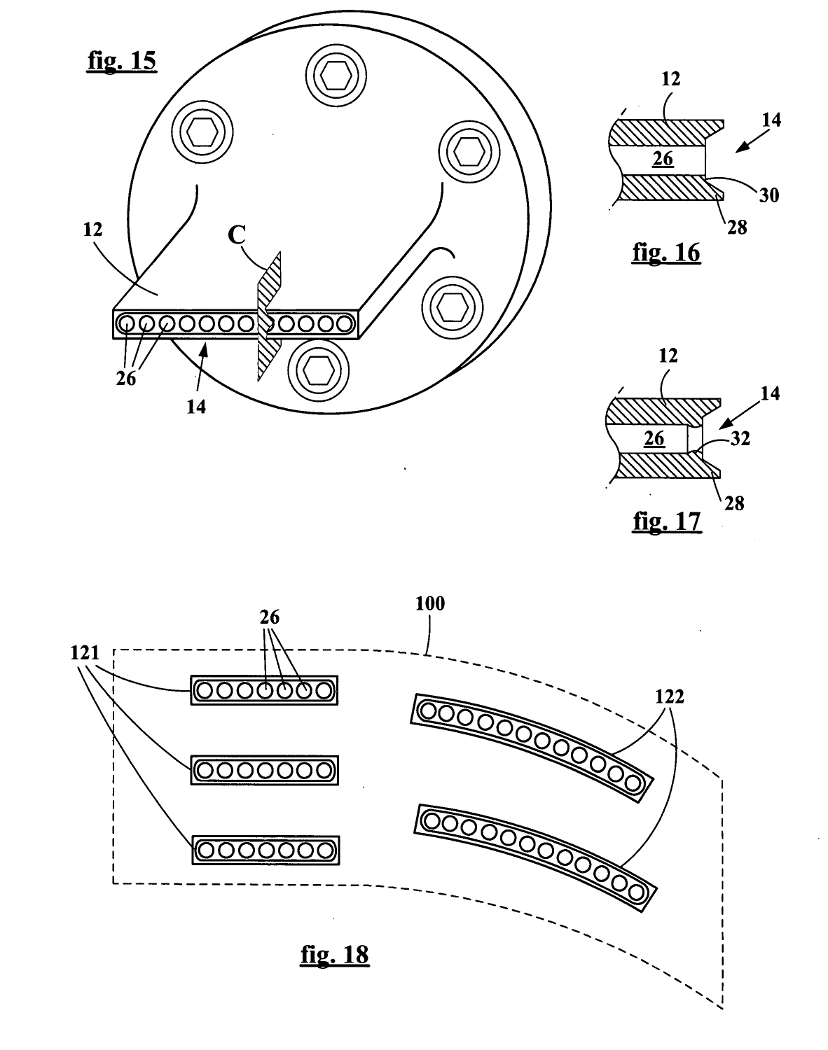

FIGS. 15 to 17 show an example of a nozzle that can be used in the manufacturing device according to the invention;

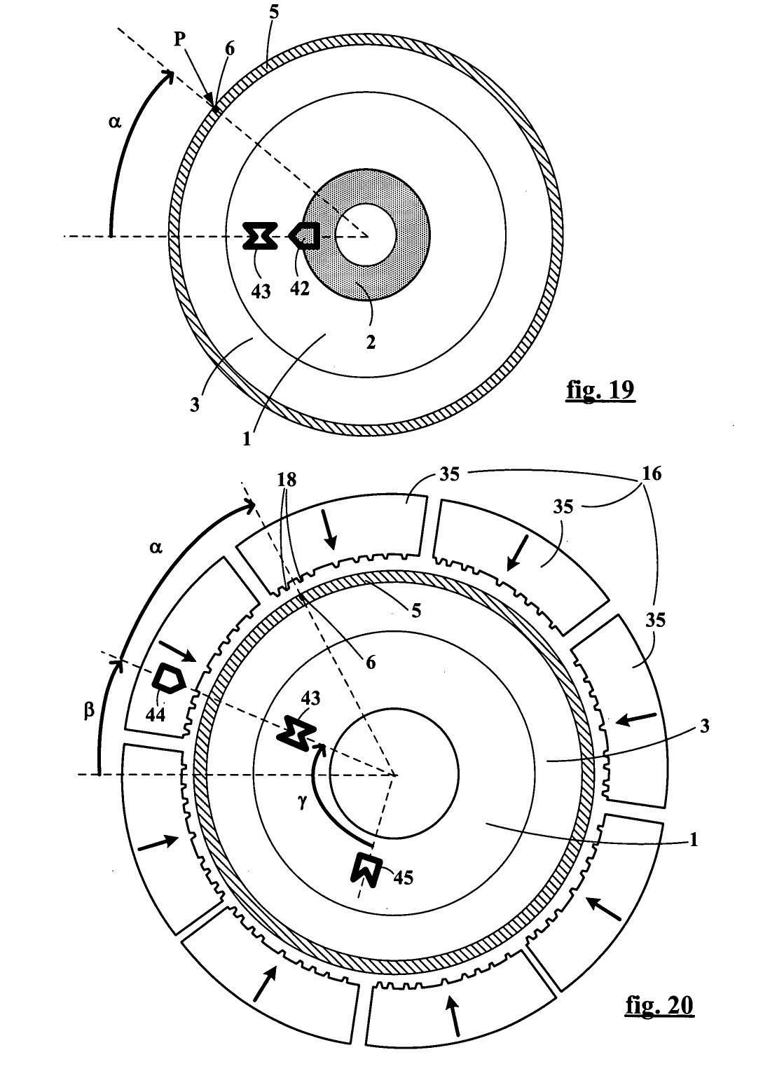

FIG. 18 illustrates another example of nozzles according to the invention; and

FIGS. 19 and 20 illustrate the principle of a preferred embodiment of the invention.

FIG. 1 shows an uncured tire 3, that is to say as it is before its final molding operation (the term “blank” is also used). The uncured tire comprises a radially external part 5, generally called the “crown”, which appears here in cross section.

FIG. 2 is a more detailed, but just as schematic, view of the region bounded by the circle B in FIG. 1. The crown 5 mainly comprises the tread 7 and structural reinforcements. The structural reinforcement 9 (carcass, crown or protective reinforcements, which may be radial, bias or circumferential) has been shown schematically by a dotted line. The tread 7 consists predominantly of a base elastomeric material (or “compound”) and includes at least one insert 6 of an elastomeric material different from the base elastomeric material. This insert is placed in the uncured tread in a defined position P.

For convenience in the rest of the description, the base elastomeric material will be called “base compound” (MB) and the different elastomeric material constituting the insert(s) will be called “insertion compound” (MI).

One way of implementing the method according to the invention is described schematically by the series of FIGS. 3 to 8, which show a complete cycle for inserting a compound into an uncured tread.

In FIG. 3, a compound insertion device 10 capable of conveying a defined quantity of insertion compound (MI) is positioned facing the surface 8 of the tread 7. The tread consists of an uncured base compound (MB). The insertion device 10 comprises a nozzle 12, the outlet 14 of which faces the uncured tread.

In FIG. 4, the nozzle 12 is sunk into the uncured tread 7 in a substantially radial direction. Preferably, the nozzle is sunk to a depth substantially equal to the depth of the envisaged insert. A cavity 15 (the shape of which corresponds to the shape of the end of the nozzle 12) is therefore formed in the uncured tread. Nozzle positioning means (not shown) allow the nozzle to be moved at least radially relative to the tread.

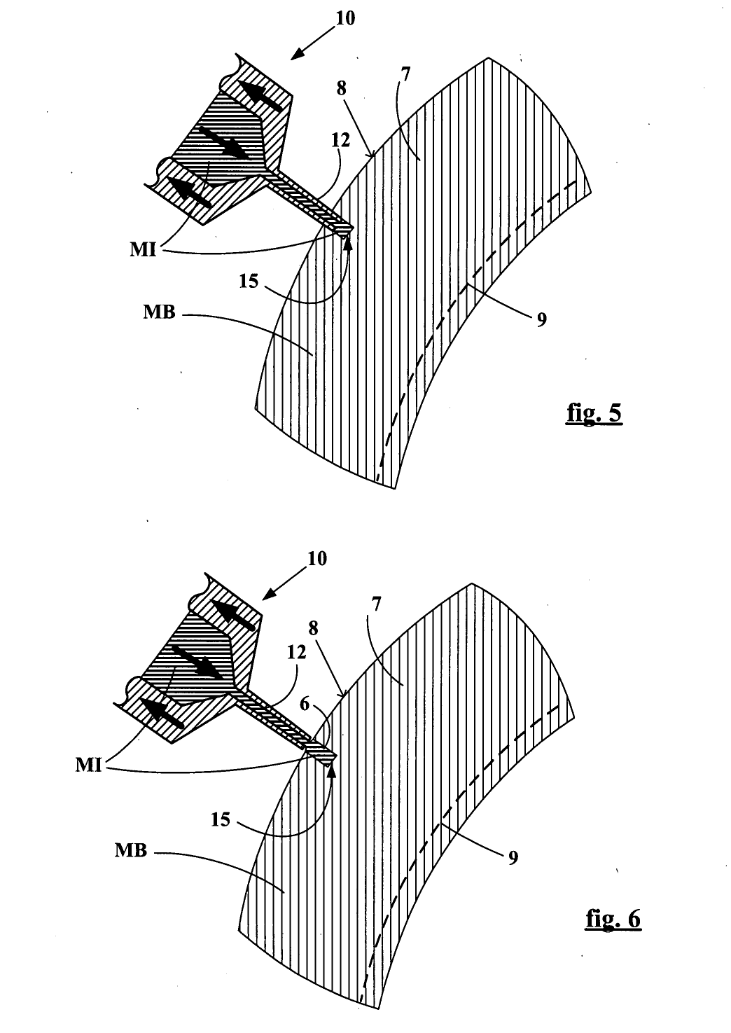

In FIG. 5, the insertion compound MI is injected into the cavity 15. The nozzle 12 of the insertion device is extracted from the cavity 15 in the uncured tread at the latest during injection of the insertion compound. Preferably, as shown here, the nozzle is progressively extracted during injection, and at a rate corresponding to the flow rate of insertion compound MI. This precaution prevents the cavity created by the nozzle from closing up (owing to reflux of the displaced base compound) before being filled with the insertion compound. However, the nozzle may also be extracted from the uncured tread before injection of the insertion compound, or even after injection.

In FIG. 6, the supply of insertion compound continues until the cavity 15 is substantially filled. The nozzle is then fully extracted from the cavity.

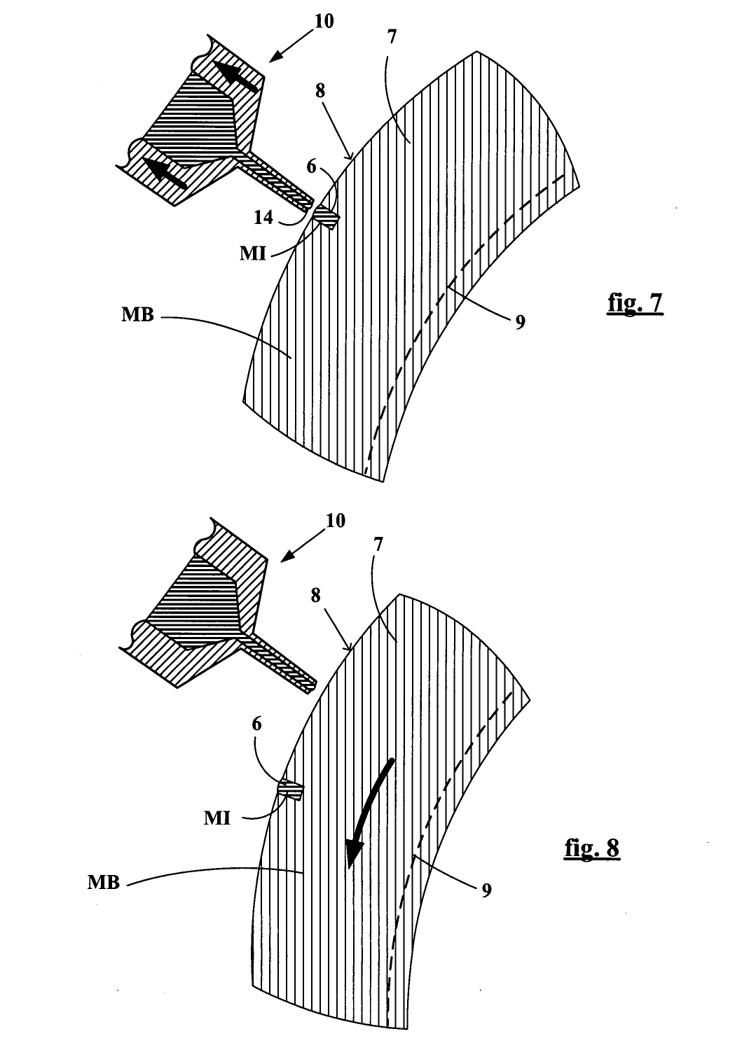

In FIG. 7, the supply of insertion compound is interrupted and the withdrawal of the nozzle continues so that the insertion compound is broken at the nozzle outlet 14.

In FIG. 8, the tread provided with a first insert 6 is moved relative to the insertion device 10 (or vice versa) and a new compound insertion cycle can commence. In this figure, the rotational movement of the tread 7 has been indicated. However, the movement may of course be axial, or both rotational and axial. The steps described above can then be repeated the number of times needed to insert the desired number of inserts, which inserts are, moreover, identical or different.

As has been seen, the invention allows a defined amount of a different compound to be inserted into an uncured tread for the purpose of its subsequent molding, and therefore its curing. The method according to the invention can therefore furthermore include a particular molding step. FIGS. 9 to 11 illustrate a preferred way of implementing the method according to the invention in which the insert 6 is formed in a particular way during the final molding of the tread.

In FIG. 9, the tread 7 with the insert 6 is placed in a mold 16 in a relative position such that the insert 6 lies facing a projection 18 of the mold, this projection being intended to mold a corresponding relief (as a depression) in the tread. In this example, the edge 19 of the projection is substantially centered with respect to the insert 6.

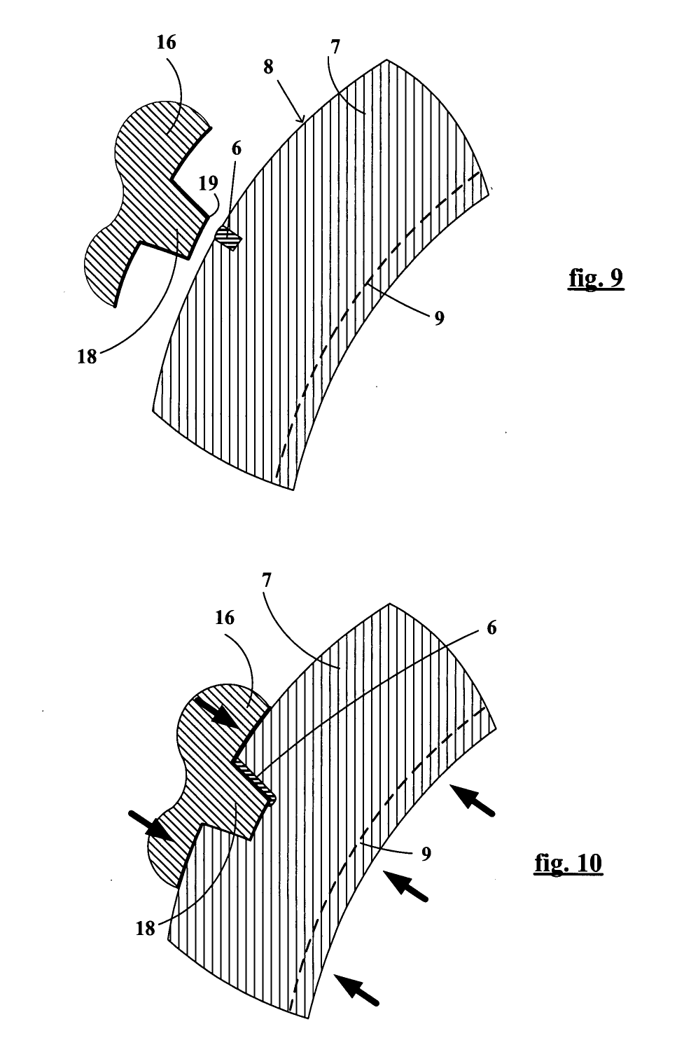

FIG. 10 shows the situation created by sinking the projection 18 into the uncured tread 7 during molding. The uncured insertion compound has been partly entrained by the edge 19. It will be understood that different results may be achieved according to the characteristics of the two compounds and the shape of the projection 18 and its edge 19, but above all according to the relative positioning between the mold and the uncured tread.

As is known per se, molding may be caused by a radial closure movement of the mold or by a radial expansion movement of the uncured tire, or by a combination of these two radial movements.

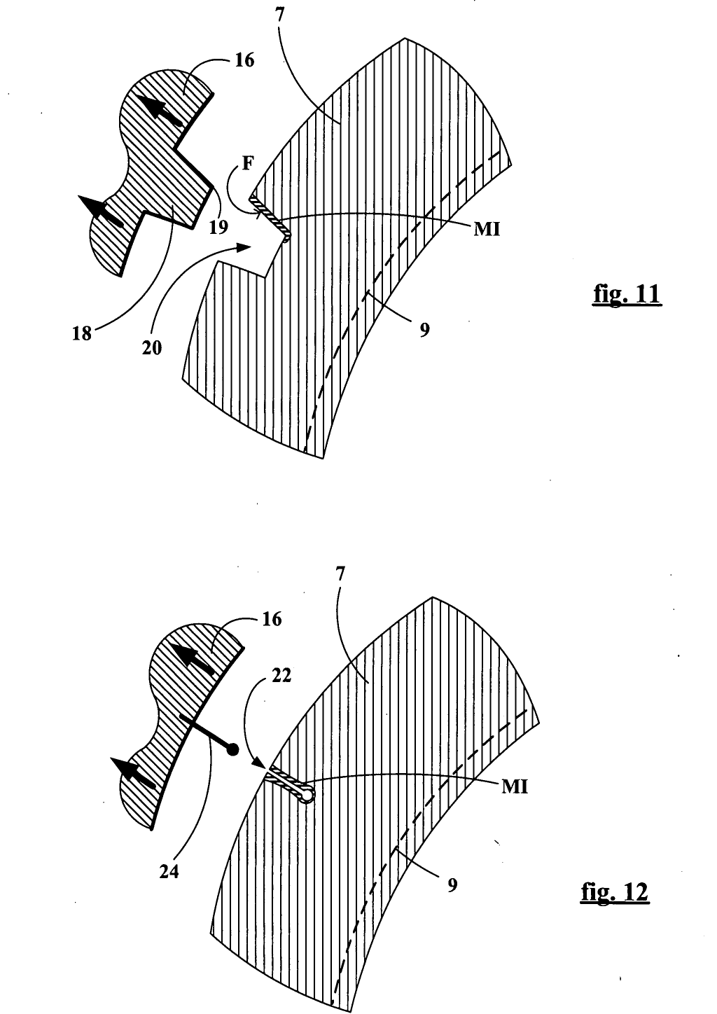

FIG. 11 shows the demolding of the tread after it has been cured. The cut 20 molded by the projection 18 includes a wall F consisting of the insertion compound MI. The other walls of the cut 20 consist here of the base compound MB. In this example, the cut 20 has a depth of about twice that of the uncured insert.

FIG. 12 shows another example of a cut. Here this is an incision 22 that has been molded using a blade 24. In this example, the end of the blade is thickened. The two walls of the incision 22 are covered here with a layer of insertion compound MI. It will be understood that, to achieve such a result, the insert of different compound must be substantially centered with respect to the blade 24 during molding. The fact that the end of the blade is thickened promotes displacement of the insertion compound. A thin flat blade would have the tendency to slice the compound, minimizing its displacement. In either case, the walls of the incision consist entirely or partly of the insertion compound.

FIG. 13 shows another example of molding. In this view, the mold 16 forms two wide grooves 20 and at the same time an incision 22 in the block 21 located between the grooves. Here, all the substantially radial faces of the cuts are covered with the insertion compound MI. It will be understood that such a result can be obtained using the method described above after having placed five inserts in the uncured tread, four inserts each being positioned facing an edge 19 of the mold 16, the fifth insert facing the blade 24.

Using the principles of the invention, it is also possible to produce layers of insertion compound at the bottom of grooves or in the center of the contact area of a tread pattern element. The method according to the invention makes it possible in fact to make innumerable variants around the basic principle of molding an uncured tread containing inserts of a different compound. Examples of treads containing inserts of a different compound are described in particular in international application WO 03/089257 or European application EP 1 065 075. Most of these examples may be obtained using the present method by injecting an appropriate number of inserts at appropriate positions in the uncured tread.

The method of the invention may also be carried out on intermediate base compound layers when the tread is produced by successively stacking two or more layers of base compound. Such an example is shown in FIG. 14. In this figure, the thickness of the tread pattern blocks 21 consists of two successive layers of base compound (MB1 and MB2). After the first layer (MB1) has been placed, a first series of inserts 61 is injected using the method described above. After the second layer (MB2) has been placed, a second series of inserts 62 is injected. The inserts 62 are offset relative to the inserts 61. If for the example the wear properties of the insertion compound are different from those of the base compound, such a construction may allow the tread pattern to evolve as it wears, so as to retain shallow incisions as described in application EP 1 065 075.

FIG. 15 shows an example of a nozzle 12 of the compound insertion device according to the invention. The nozzle here has a flattened shape and a rectangular external cross section. Such a nozzle, when it is inserted radially into the uncured tread (as described in FIG. 4), will have the effect of forming a substantially parallelepipedal cavity 15. The outlet 14 of the nozzle is fed by a plurality of parallel ducts 26.

FIG. 16 shows the end of the nozzle in cross section in the plane C of FIG. 15. This cross section clearly shows that the outlet 14 has a relatively voluminous mouth compared to the duct 26. This feature can promote reproducible breaking of the insertion compound at the shoulder 30 as the nozzle is being withdrawn (see FIG. 7). For the same purpose, for a given feed cross section, it may be preferable to use a large number of small ducts rather than a smaller number of larger ducts. The appropriate number of ducts also depends on the profile of the nozzle in question.

FIG. 17 shows a preferred variant of the nozzle of FIG. 15, in which the ducts 26 also have a narrowing 32 in their final cross section, in order to further facilitate localized separation from the insert.

The thickness of the nozzle may for example vary from 2 to 10 mm for producing the examples illustrated here, the width of the nozzle then preferably being comparable to the width of the intended pattern blocks on the tread.

Within the context of the invention, several nozzles may be used in parallel, these being fed by single feed means and positioned relative to the tread by single positioning means.

It is also possible to employ simultaneously, on the same tire blank, several compound insertion devices 10, each of these devices emerging in one or more nozzles.

When the position and/or the shape of the inserts are/is associated with the pattern elements of the molded tread and when the tread pattern comprises a repetition of one or more base pattern features around the circumference of the tread, it may be advantageous to inject all the inserts corresponding to a base pattern feature in a single operation. Thus, the number of injection operations is reduced to the number of repeats of the base pattern feature(s). FIG. 18 illustrates this possibility, in which three nozzles 121 and two nozzles 122 are placed so as to allow simultaneous injection of five inserts. This assembly may cover part of the tread corresponding to a matrix 100 of the tread pattern. As is known, a matrix is a part of the tread pattern corresponding to a base pattern feature repeated several times over the entire tire tread pattern. The complete tread pattern may use a single matrix or several (for example two or three) different matrices.

The nozzles of a matrix may be integral and fed by common means. If the tread pattern comprises different matrices, it may be necessary to provide sets of nozzles that are also different.

In the example shown in FIG. 18, the matrix 100 covers substantially half the width of the tread.

The means for feeding the nozzle(s) with the insertion compound may be an extruder. The output of the extruder may be controlled by the speed of rotation of its screw or by any other flow control device. Preferably, the extruder is a volumetric extruder, that is to say an extruder whose output can be controlled relatively precisely by controlling the speed of rotation of its screw. Document EP 690 229 describes examples of volumetric extruders.

Control of the manufacturing process (start and finish of the injection of each insert or group of inserts, rotation of the former, radial and axial displacements of the nozzle) may therefore preferably be based on the rotation of the screw of the volumetric extruder. The method according to the invention can be carried out with a high cycle rate, for example around one complete cycle (positioning of the nozzle and injection of the insert) per second.

The method of the invention is preferably used within the context of manufacturing tires on a core. It is then preferred to use indexing means, the principle of which is illustrated in FIGS. 19 and 20. For the sake of clarity of the drawing, these figures show a single insert 6, but as described above the method according to the invention allows an unlimited number of inserts to be placed.

FIG. 19 shows the tire of FIG. 1 during its manufacture according to a preferred embodiment of the invention. The uncured tire here is built on a rotary core 1 by winding long lengths of materials and/or by successive deposition of shorter elements. The core 1 is driven by a drive member, such as a spindle or a hub 2. The position of the core 1 relative to the hub 2 is set by first indexing means (shown symbolically here by first indices 42 and 43 of complementary shapes and positions facing each other). The angular position of the core 1 during its rotation can therefore be controlled in relation to the control of the various laying tools, including the compound insertion device described above. There are many known indexing means such as, for example, a groove/key system or a fitting comprising a flat or any other assembly shape allowing only a single relative angular position. The angular position of the spindle or hub 2 is controlled directly or indirectly in a manner known per se, for example by an incremental coder.

Thus, when an insert 6 is placed in the uncured tread, the position P of this insert relative to the core 1 is completely reproducible. This position P may be made up of three elements, which will now be explained in detail:

the radial position of the insert (in the thickness direction of the tread) is given by the method of insertion, for example according to the depth of insertion of the nozzle into the tread and control of the nozzle flow rate;

a the transverse position of the insert (in the axial direction of the tire) is also given by the method of insertion and in particular by the axial position of the nozzle and by its shape; and

finally, the circumferential position of the insert (for example the azimuth α) relative to the core is controlled by the indexing system, for example as described above.

After the uncured tire has been assembled, that is to say when all its constituent elements have been placed on the core (including the insert or inserts), this assembly (core plus uncured tire) is placed in an external mold that gives the tire, and particularly its tread, its final shape.

FIG. 20 shows the step in the manufacturing process during which the uncured tire assembled on its core is placed in an external mold 16 (shown symbolically here by molding sectors 35). The sectors 35 include projections 18 intended to form negative reliefs on the surface of the tire (see FIGS. 9 to 13). In order for the position of the insert 6 (and in particular its azimuth) relative to the grooves or incisions in the molded tread to be reproducible from one tire to another, the core supporting the uncured tire is positioned reproducibly with respect to the external mold (that is to say here with respect to the sectors 35). This may be obtained thanks to second indexing means similar to the first indexing means described above for placing the inserts. The second indexing means comprise a second index associated with the core and a complementary second index associated with the external mold. Of course, it is possible to use second indices (44, 45) that are independent of the first indices (42, 43). It is also possible to use the first index (43) associated with the core, said first index cooperating this time with the complementary second index (44) associated with the mold provided that the angular positioning of the tire in the mold is reproducible during manufacturing cycles. It will of course be understood in this figure that any point on the core is stationary relative to the position P of the insert 6. It is therefore possible to associate any point (but only one) on the core with any point (but only one) on the external mold so that the angular position of the insert in the mold is reproduced from one manufacturing cycle to another. Taking the example described in FIG. 20 in which the indices 44 and 43 are used as second indexing means, the insert 6 considered here will, in each manufacturing cycle, described above. There are many known indexing means such as, for example, a groove/key system or a fitting comprising a flat or any other assembly shape allowing only a single relative angular position. The angular position of the spindle or hub 2 is controlled directly or indirectly in a manner known per se, for example by an incremental coder.

Thus, when an insert 6 is placed in the uncured tread, the position P of this insert relative to the core 1 is completely reproducible. This position P may be made up of three elements, which will now be explained in detail:

the radial position of the insert (in the thickness direction of the tread) is given by the method of insertion, for example according to the depth of insertion of the nozzle into the tread and control of the nozzle flow rate;

the transverse position of the insert (in the axial direction of the tire) is also given by the method of insertion and in particular by the axial position of the nozzle and by its shape; and

finally, the circumferential position of the insert (for example the azimuth α) relative to the core is controlled by the indexing system, for example as described above.

After the uncured tire has been assembled, that is to say when all its constituent elements have been placed on the core (including the insert or inserts), this assembly (core plus uncured tire) is placed in an external mold that gives the tire, and particularly its tread, its final shape.

FIG. 20 shows the step in the manufacturing process during which the uncured tire assembled on its core is placed in an external mold 16 (shown symbolically here by molding sectors 35). The sectors 35 include projections 18 intended to form negative reliefs on the surface of the tire (see FIGS. 9 to 13). In order for the position of the insert 6 (and in particular its azimuth) relative to the grooves or incisions in the molded tread to be reproducible from one tire to another, the core supporting the uncured tire is positioned reproducibly with respect to the external mold (that is to say here with respect to the sectors 35). This may be obtained thanks to second indexing means similar to the first indexing means described above for placing the inserts. The second indexing means comprise a second index associated with the core and a complementary second index associated with the external mold. Of course, it is possible to use second indices (44, 45) that are independent of the first indices (42, 43). It is also possible to use the first index (43) associated with the core, said first index cooperating this time with the complementary second index (44) associated with the mold provided that the angular positioning of the tire in the mold is reproducible during manufacturing cycles. It will of course be understood in this figure that any point on the core is stationary relative to the position P of the insert 6. It is therefore possible to associate any point (but only one) on the core with any point (but only one) on the external mold so that the angular position of the insert in the mold is reproduced from one manufacturing cycle to another. Taking the example described in FIG. 20 in which the indices 44 and 43 are used as second indexing means, the insert 6 considered here will, in each manufacturing cycle, that is to say in each tire manufactured, be positioned with respect to the mold (considered to be stationary) at the azimuth α+β relative to the horizontal. In contrast, if the indexing during molding uses the combination of indices 44 and 45 as second indexing means, the insert 6 will, in each manufacturing cycle, be positioned with respect to the mold at the azimuth α+β+γ relative to the horizontal, since the index 45 is offset relative to the index 43 by an angle γ.

The second indexing means may also operate at the tools (not shown) that are used to manipulate the core for the purpose of molding after the uncured tire has been assembled. A hub identical or similar to the hub 2 of FIG. 19 may serve for angularly positioning and/or transporting the core within the mold. The second indexation takes place in this case via the center and no longer via the periphery of the core as shown in FIG. 20.

Reproducible positioning may also be achieved in the following manner. When the core supporting the uncured tire is placed in the same angular position at the end of each cycle of placing the inserts, the core is transported and placed in the mold so as to avoid any rotation (or allowing rotation through a constant angle). This may be accomplished in a simple manner, for example by a translation along rails or by a carousel rotation from the insertion station to the molding station.

When the tire tread pattern (or the part of the tread pattern intended) includes a pattern feature that repeats two or more times along the circumference (see above in the description of a matrix illustrated in FIG. 18), that is to say the inserts may adopt several positions for an identical effect during molding, it is possible of course to use indexing means having a corresponding number of possible positions (or a submultiple of this number).

The core 1 may be of various types: it may be rigid, for example according to the teaching of document EP 0 242 840, or more or less deformable (inflatable) according to documents FR 2 005 116 or EP 0 822 047, provided that it allows both building and molding.

It has been found that the method of the invention ensures great constancy in the final positioning of the inserts within finished tires. The method of the invention may result in a discrepancy of at most 1 mm along the circumference of a passenger car or motorcycle tire.

The choice of elastomeric insertion material MI depends of course on the function that it has to provide in the finished tire. However, it is preferred to use an elastomeric material whose mechanical properties in the uncured state promote tensile fracture so as to obtain sufficiently reproducible separation (see the description of FIGS. 7 and 15 to 17).

When it is stated that an elastomeric material is “uncured”, this means that it is not “cured” with respect to crosslinking, which is generally carried out during the final molding of the tires. In practice, crosslinking may be initiated before molding, for example owing to the increase in temperature caused by the extrusion. Thus, it should be understood that the elastomeric material is said to be “uncured” until it has been completely crosslinked.

The invention applies particularly to the production of multi-material treads. Of course, the invention may be applied, with necessary modification, to other regions of the tire.

In general, the term “tire” employed in the present patent specification covers, of course, any type of elastic casing, whether or not pneumatic, the invention essentially relating to the molding of this “tire” and not to its operation.

1. A method of manufacturing a tire, said tire including a tread (7) essentially consisting of a base compound (MB), the tread furthermore including at least one insert (6) of an insertion compound (MI), said method comprising steps consisting in:
preparing a tread made of an uncured base compound;
injecting, into the uncured tread, a defined quantity of the uncured insertion compound in a position (P) defined in relation to the uncured tread;
molding said tread.

2. The method as claimed in claim 1, in which the insertion compound is injected into the uncured tread via a nozzle (12) after the end of the nozzle has been sunk into the uncured tread.

3. The method as claimed in claim 2, in which the end of the nozzle (12) is extracted from the uncured tread at the latest during injection of the insertion compound.

4. The method as claimed in claim 2, in which the insertion compound is conveyed toward the end (14) of the nozzle (12) using an extruder (10).

5. The method as claimed in claim 4, in which the extruder is a volumetric extruder (10).

6. The method as claimed in claim 2, in which the insertion compound is conveyed toward the end of the nozzle via a plurality of substantially parallel ducts (26).

7. The method as claimed in claim 1, in which the final tread molding step is carried out so as to form cuts (20, 22) in the surface of the tread, at least one wall (F) of said cuts consisting at least partly of insertion compound (MI).

8. The method as claimed in claim 1, in which a plurality of inserts are injected simultaneously so as to cover part of the tread corresponding to a base pattern of the tire tread pattern.

9. The method as claimed in claim 1, in which the tire is assembled and molded on a core (1), the shape of the core being close to the final shape of the internal cavity of the tire.

10. The method as claimed in claim 9, the molded tread including a tread pattern, the position (P) of said insert being defined relative to the tread pattern, said method comprising the steps consisting in:
injecting said insert (6) into the uncured tread (7) in a position (P, α) defined relative to the core;
positioning said core carrying said uncured tire (3) and said insert in an external mold (35) along a defined azimuth (β).

11. A device for manufacturing a tire according to the method of claim 1, said device comprising a rotary core (1) capable of supporting the uncured tire (3), feed means (10) for feeding a nozzle (12) with an uncured insertion compound and means for positioning the nozzle relative to the core.

12. The device as claimed in claim 11, in which the external shape of the end of the nozzle corresponds substantially to the shape of the insert.

13. The device as claimed in claim 11, in which the means for feeding the uncured insertion compound comprise an extruder.

14. The device as claimed in claim 13, in which the means for feeding the uncured insertion compound comprise a volumetric extruder.

15. The device as claimed in claim 11, which furthermore includes means for indexing the position of the insert(s) relative to the molded tread.

16. The device as claimed in claim 15, in which the indexing means comprise a first index (43) associated with the core (1) and capable of cooperating with a complementary first index (42) associated with a driving member (2) for driving the core during assembly of the uncured tire and including a second index (43; 45) associated with the core and capable of cooperating, during molding, with a complementary second index (44) associated with the external mold (35).

17. The device as claimed in claim 16, in which the first and second indices constitute a single means (43).

18. The device as claimed in claim 11, in which the nozzle comprises a plurality of essentially parallel ducts (26).

19. The device as claimed in claim 11, comprising a plurality of integral nozzles arranged according to a base pattern feature of the tire tread pattern, said plurality of nozzles being fed by common feed means (10).
